(19) United States
(12) Patent Application Publication
(10) Pub. No.: US 2003/0149970 A1
(43) Pub. Date: Aug. 7, 2003

(54) Portable software for rolling upgrades

(76) Inventors: Vedvyas Shanbhogue, Los Angeles, CA (US); David J. Hong, Torrance, CA (US); Nagunuri Sridhar, Santa Monica, CA (US); Chirayu Patel, Bangalore (IN); Sagar R. Jogadhenu Pratap, Los Angeles, CA (US)

Correspondence Address: KENYON & KENYON, 1500 K STREET, N.W., SUITE 700, WASHINGTON, DC, 20005, US

(21) Appl. No.: 10/052,441

(22) Filed: Jan. 23, 2002

(51) Int. Cl. G06F 9/44; G06F 9/00

(52) U.S. Cl. 717/170; 709/328

(57) ABSTRACT

An upgradable computer system has a first software component and a second software component, in which the first and second software components operate at a current version. The computer system upgrades the first software component to an upgraded version and validates the performance of the upgraded first software component. The validation includes translating messages originating at the first software component from an upgraded version format to a current version format.

### FIELD OF THE INVENTION

The present invention is directed to fault tolerant systems. More particularly, the present invention is directed to portable software for upgrades of fault tolerant systems.

### BACKGROUND INFORMATION

As computer systems, network systems and software systems become more complex and capital intensive, system failures become more and more unacceptable. This is true even if the system failures are minor. Generally, when systems fail, data is lost, applications become inaccessible, and computer downtime increases. Reducing system failures is often a major goal for companies that wish to provide quality performance and product reliability in the computer systems, network systems and/or software systems which they operate. As such, these systems must be highly dependable. Fault tolerance has been implemented as a way of achieving dependability.

For a system to be fault tolerant, it must be able to detect, diagnose, confine, mask, compensate, and/or recover from faults. In general, there are three levels at which fault tolerance may be applied: hardware level, software level and system level. In the hardware level, fault tolerance is often achieved by managing extra hardware resources, through redundant communications, additional memory, duplicate processors, redundant power supply, etc. In the software level, computer software is structured to compensate for faults resulting from changes in data structures or applications because of transient errors, design inaccuracies, or outside attacks. In the system level, system fault tolerance provides functions that compensate for failures that are generally not computer-based. For example, application-specific software may detect and compensate for failures in sensors, actuators, or transducers.

Even in the hardware level and the system level, application software is generally utilized to control, provide and/or assist in the detection and recovering of fault. As such, it is essential that to achieve system fault tolerance, application software itself must be fault tolerant. Hardware is generally a couple of orders of magnitude more reliable than software, and the majority of the failures in today's systems that incorporate software applications are in fact typically caused by software problems.

Fault tolerance is typically achieved in application software by either the underlying operating system and hardware or by customizing the application to operate in an active/standby redundant configuration. However, when an application uses the underlying operating system and hardware to achieve fault tolerance, it becomes dependent upon, or “tied down” to that operating system and hardware platform.

Application software in most systems are required to be upgraded from time to time to upgrade the software by incorporating new features or fix bugs. Most current mechanisms of upgrading software involve shutting down the system and reloading the system with the upgraded software. Known mechanisms to perform software upgrades without shutting down the system are also typically based on the characteristics and capabilities of the platform on which these mechanisms are implemented.

Based on the foregoing, there is a need for an improved system and method that allows software on a fault tolerant system or distributed fault tolerant system to be upgraded without shutting down the system, or without being based on the characteristics and capabilities of the platform.

### BRIEF DESCRIPTION OF THE DRAWINGS

FIG. 1 is a block diagram of a computer system in accordance with one embodiment of the present invention.

FIG. 2 is a block diagram of a non-upgraded software component and an upgraded software component in accordance with one embodiment of the present invention.

FIG. 3 is a flow chart illustrating steps performed in accordance with one embodiment of the present invention for implementing rolling upgrades of a computer system.

FIG. 4 is a block diagram illustrating the placement of translation functions in the software components.

### DETAILED DESCRIPTION

One embodiment of the present invention is a fault tolerant system or distributed fault tolerant system in which application software is upgraded using a rolling upgrade method. During the upgrading, upgraded and non-upgraded copies of the application software co-exist in the system while the performance of the upgraded version of the software is being validated. In one embodiment, a translation function on upgraded software components allow the upgraded components to communicate with the non-upgraded components.

One embodiment of the present invention allows the computer system to be upgraded with a new version of software without loss of system availability and service availability and allows upgraded and non-upgraded versions of the software to co-exist in the system for the duration in which the functionality of the upgraded version of the software is being validated. One embodiment of the present invention further allows fallback to the non-upgraded version of the software if the upgraded version of the software does not function satisfactorily in the validation phase. One embodiment of the present invention further allows automatic enabling of new features in the upgraded software when all software components participating in the feature have been upgraded with the capability to support the new feature.

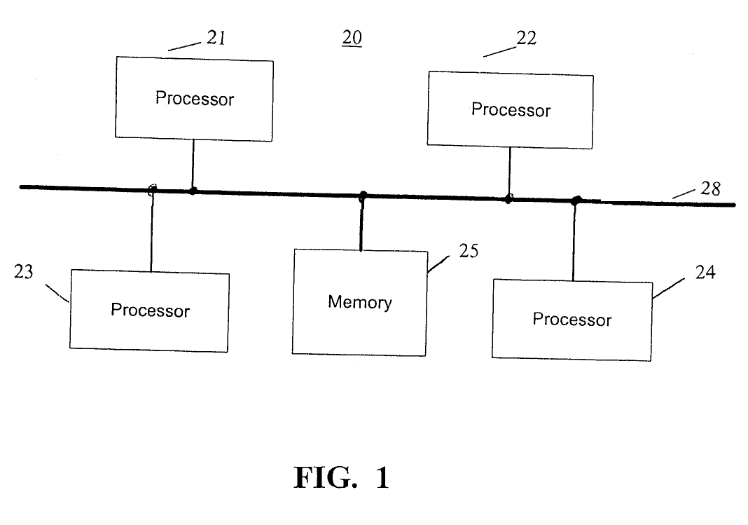

FIG. 1 is a block diagram of a computer system 20 in accordance with one embodiment of the present invention. Computer system 20 includes multiple processors 21-24. Processors 21-24 can be any type of general purpose processor. Processors 21-24 are coupled to a bus 28. Also coupled to bus 28 is memory 25. Memory 25 is any type of memory or computer readable medium capable of storing instructions that can be executed by processors 21-24.

One embodiment of computer system 20 is a fault tolerant system in which applications are made fault tolerant using a hot standby mechanism. In this embodiment, computer system 20 only includes two processors (e.g., processors 21, 22), one of which functions as an active processor, and one of which functions as a standby processor. An example of such a fault tolerant system is disclosed in U.S. patent application Ser. No. 09/967,623, entitled “System and Method for Creating Fault Tolerant Applications”, filed on Sep. 28, 2001 and assigned to Intel Corp. Another embodiment of computer system 20 is a distributed and fault tolerant system that includes more than two processors. An example of such a distributed fault tolerant system is disclosed in U.S. patent application Ser. No. 09/608,888, entitled “Apparatus and method for building distributed and fault tolerant/high-availability computer applications” filed on Jun. 30, 2000 and assigned to Intel Corp.

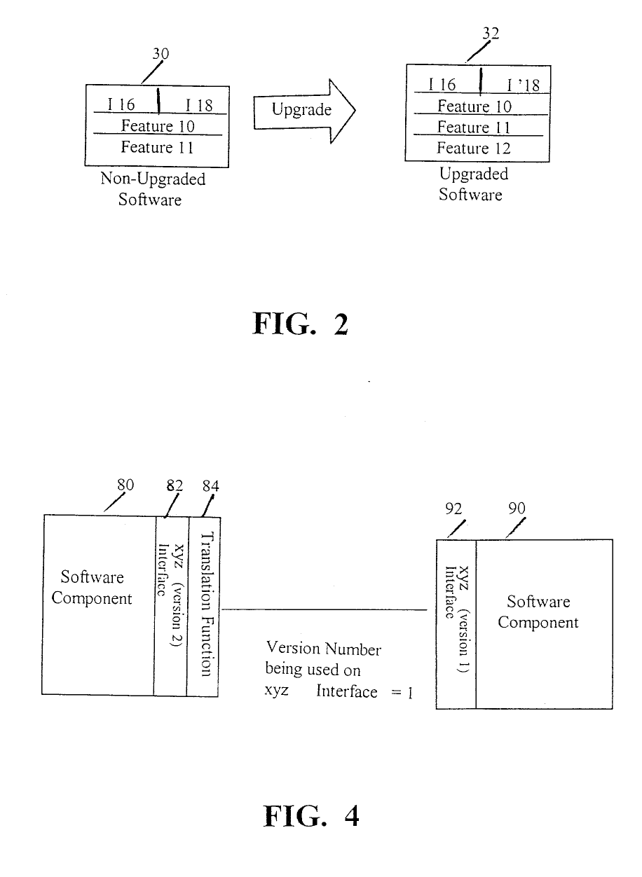

FIG. 2 is a block diagram of a non-upgraded software component 30 and an upgraded software component 32 in accordance with one embodiment of the present invention. Each component 30, 32 includes a collection of interfaces 16, 18 and features 10-12. Interfaces are means by which software components interact and connect with each other and are defined as a named collection of message and constant declarations. Each interface message has the following characteristics:

Syntax—The structural information associated with the interface message (e.g., the type and number of parameters exchanged by the software components in communication over this interface, etc.); and

Semantics—The behavior associated with the interface message (e.g., the actions taken by a software component when it receives a message over the interface, etc.).

An upgraded version of the software component may contain new or modified interfaces, such as upgraded interface 18 (“I' 18”) of software component 32. Some of the software interfaces may even have been deleted. The upgraded software can contain new or modified features, such as feature 12 of software component 32, and some of the software features may have been deleted.

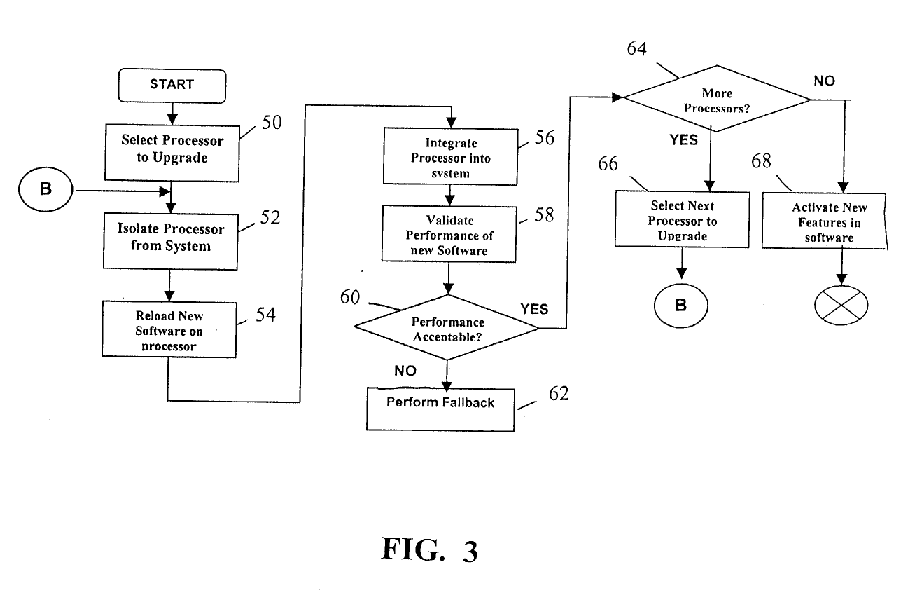

FIG. 3 is a flow chart illustrating steps performed in accordance with one embodiment of the present invention for implementing rolling upgrades of computer system 20. In the embodiment described, the steps are stored as software in memory 25 and executed by processors 21-24. In other embodiments, the steps are performed by any combination of hardware or software.

A processor is selected for rolling upgrade (step 50) and is isolated from the rest of the system (step 52) by shutting down the software components residing on the processor. If the software component is fault-tolerant in nature, the other copy of the software component will take over and continue to provide service. If the software is distributed in nature, then the other copies of the software component take over the workload.

The processor, which has been isolated, is reloaded with upgraded software (step 54) and is configured. The software is configured with a configuration equivalent to that existing in the system before attempting a rolling upgrade (i.e., new features in the upgraded software are kept disabled).

The reloaded processor is re-integrated into the system (step 56) and starts providing service.

The performance of the upgraded software is validated (step 58). If the validation fails (step 60) the process enters a fallback phase (step 62). In the fallback phase, all upgraded software components in the system are taken through an isolation, reload and integration cycle using the older version of the software. At the end of the fallback phase the system falls back to the old software version.

If the validation of the upgraded software components has been performed and the performance is found to be acceptable, the process enters a closure phase. In this phase, the other processors in the system are taken through the isolation, reload and integration phases (steps 64, 66, etc.).

After completion of the closure phase all software components in the system are now upgraded and new features in the upgraded software are activated (step 68).

If the software component is fault tolerant (i.e., has an active and a standby copy) or distributed (i.e., has multiple active and standby copies) the different processors hosting the active and standby copies of the application may be upgraded in an asynchronous manner at different times. Therefore, during the validation phase of the rolling upgrade process (step 58), upgraded and non-upgraded copies of the software components may have to co-exist. The software component, which is being upgraded, may have to communicate with other software components in the system. Different software components in the system may be upgraded at different times.

As shown in FIG. 2, an upgraded version of a software component may contain new or modified interfaces and features. Therefore, an upgraded version of the software component should be able to adapt its interfaces and features to communicate with a non-upgraded software component. In addition, an upgraded copy of a software component in a distributed or fault tolerant environment may have to communicate with its peers or standby copies, which may not have been upgraded.

To achieve this, in one embodiment of the present invention each interface of the software component is tagged with an interface version number. When the interface undergoes change (i.e., the syntax or semantics associated with the interface messages changes), the interface version number is incremented. Each interface version has is composed of a major number and a minor number. The major version number is incremented when the changes are made to the latest version of the interface and the minor version number is incremented when the changes are made to an older version of the interface.

When a new processor has to be integrated into the system (step 56), the following operations are performed:

1. Query the version numbers of the interfaces implemented by the software components on the processor to be integrated.

2. Based on the capabilities of the interface version numbers supported by the other software components in the system, arrive at a compatible interface version to be used on each of the software component interfaces. This version number is the highest compatible interface version number implemented by all software components sharing that interface.

3. Indicate to the software components the interface version number to be used on each of the software component interfaces. The software components use this interface version number to adapt the respective interfaces.

In one embodiment of the present invention, the software component implementing the higher version of the interface adapts to communicate with a software component implementing a lower version of the interface. If a software component has to communicate over an interface to another software component implementing a lower version of the interface, the component implementing the higher interface version invokes translation functions to translate the interface message parameters from the order and type defined for the interface version implemented by the software component to the order and type defined by the lower version of the interface. The version number used to form the message is also sent to the destination of the message.

At the destination of the message if the version number used to form the message (encoded into the message by the originator) is lower than the version number of the interface implemented by the destination, the message is passed through a translation function to translate the interface message parameters from the order and type defined for the interface version implemented by the destination.

FIG. 4 is a block diagram illustrating the placement of translation functions in the software components. Software components 80, 90 communicate over an XYZ interface 82, 92, where 82 is the XYZ interface implemented by software component 80 and 92 is the XYZ interface implemented by software component 90. Software component 80 implements version 2 of XYZ interface 82. Software component 90 implements version 1 of XYZ interface 92. The rolling upgrade architecture in accordance to one embodiment of the present invention directs both the software components to use version 1 on the XYZ interface.

The software component implementing the higher version of the interface has to adapt to the interface and therefore software component 80 passes all messages it originates over interface 82 towards software component 90 through a translation function 84 to convert from version 2 formats to version 1 formats. When software component 90 is upgraded to support version 2 of XYZ interface 92, the rolling upgrade architecture directs both software components to start using version 2 for originating messages over this interface.

The following pseudo-code provides the structure of translation function

PROCEDURE TranslateAndSendMessageA

INPUT RemoteVersion
INPUT MessageAParams
START

SWITCH (RemoteVersion)

Case SELF_VERSION:

/* SELF_VERSION is version implemented by component sending the message */
i. Send message;

Case SELF_VERSION − 1:

i. Convert MessageAParams from SELF_VERSION to SELF_VERSION − 1

format

ii. Send Message

Case SELF_VERSION − 2:

...

ENDSWITCH

FINISH
PROCEDURE ReceiveAndTranslateMessageA
INPUT IncomingVersion
INPUT MessageAParams
START

SWITCH (IncomingVersion)

Case SELF_VERSION:

/* SELF_VERSION is version implemented by component receiving the message */
i. Process Message;

Case SELF_VERSION − 1:

| | |
|---|---|
| i. | Convert MessageAParams from SELF_VERSION−1 to SELF_VERSION |
| | format |
| ii. | Process Message |

Case SELF_VERSION − 2:

...

ENDSWITCH

FINISH

In one embodiment, the higher version of the interface may introduce new parameters in the message. When a destination receives a message formed using a lower version of the message, it would have to derive the value of this new parameter from the other message parameters. In cases where such derivation is not possible, the translation functions can be instructed to substitute configurable default values for these parameters. Deleted and modified parameters are adapted in a similar manner.

The message may also contain certain parameters under compile time flags. In one embodiment, the rolling upgradable system is reloaded with same version of software but compiled with a different set of compile time flags. Hence even though the version numbers of the interfaces implemented by all software components is same, the message packing order and format may change due to different set of compile time flags being enabled at the originator and the destination. In one embodiment, this issue is solved by the translation functions by introducing a bit vector into the message. Each bit of the bit vector indicates the state of a compile time flag at the originator of the message. The destination of the message then bases its message decoding decisions on the bits indicated in the message and the compile time flags enabled at the destination of the message.

The following pseudo-code can provide the handling of the bit vector at the originator of the message:

FOR each compile time flag emabled at originator

Set corresponding bit in bit vector

ENDFOR
Encode bit vector in the message sent to destination

The following pseudo-code can provide the handling of the bit vector at the destination of the message:

FOR each message parameter under compile time flag

IF compile time flag enabled at destination
THEN

IF bit vector indicates compile time flag enabled at originator
THEN

Decode parameter from message for use

ELSE

Assume Default Value for parameter

ENDIF

ELSE

IF bit vector indicates compile time flag enabled at originator
THEN

Decode parameter from message and discard

ENDIF

ENDFOR

In one embodiment, the upgraded software components may have support for new features. The new features implemented by the upgraded software component should not be activated until all software components participating in the feature have been upgraded. Therefore, during the validation phase (step 58) of the rolling upgrade process, new features introduced in the upgraded software components should be disabled.

After all copies of all the software components participating in a feature have been upgraded using the rolling upgrade process in accordance with the present invention, the new features may be activated. Software component features may be activated by one of the following mechanisms:

Features activated by configuration—A new configuration has to be provided to activate the new feature.

Features activated by control—A command has to be issued to the software component to active the new feature.

Features activated by version synchronization—Certain features introduced in the software component may not require any new configuration for their activation. However they may be dependent on the interface capabilities for their proper function. When all software components participating in the feature have been upgraded, the upgraded software component is asked to use the latest version of the interface as described in the rolling upgrade process. When this event happens such features can become activated automatically.

As described, one embodiment of present invention allows application software to be upgraded using a rolling upgrade method in a fault tolerant system or distributed fault tolerant system. During the upgrading, upgraded and non-upgraded copies of the application software co-exist in the system while the upgraded version of the software is being validated through the use of a translation function.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of upgrading a computer system having a first software component and a second software component, said first and second software components operating at a current version, said method comprising:
upgrading the first software component to an upgraded version; and
validating the performance of the upgraded first software component, said validating comprising translating messages originating at the first software component from an upgraded version format to a current version format.

2. The method of claim 1, wherein said computer system comprises a first processor executing the first software component and a second processor executing the second software component.

3. The method of claim 1, wherein the first software component comprises at least one interface, and said upgrading comprises upgrading the interface.

4. The method of claim 1, further comprising:
querying a version of the first software component and the second software component; and
determining a compatible version for the computer system.

5. The method of claim 4, wherein the compatible version is the current version.

6. The method of claim 1, wherein said upgrading comprises adding new features and said validating comprises disabling the new features.

7. The method of claim 6, further comprising activating the new features if the validating is acceptable.

8. The method of claim 1, further comprising upgrading the second software component to the upgraded version if the validating is acceptable.

9. A computer system comprising:
a first processor;
a second processor coupled to said first processor;
a computer readable memory having instructions stored thereon that cause a first software component to be executed by said first processor, and a second software component to be executed by said second processor;
said instructions further causing said computer system to:
upgrade the first software component to an upgraded version; and
validate the performance of the upgraded first software component, said validating comprising translating messages originating at the first software component from an upgraded version format to a current version format.

10. The computer system of claim 9, wherein the first software component comprises at least one interface, and said upgrading comprises upgrading the interface.

11. The computer system of claim 9, said instructions further causing said computer system to:
query a version of the first software component and the second software component; and
determine a compatible version for the computer system.

12. The computer system of claim 11, wherein the compatible version is the current version.

13. The computer system of claim 9, wherein said upgrading comprises adding new features and said validating comprises disabling the new features.

14. The computer system of claim 13, said instructions further causing said computer system to activate the new features if the validating is acceptable.

15. The computer system of claim 9, said instructions further causing said computer system to upgrade the second software component to the upgraded version if the validating is acceptable.

16. The computer system of claim 9, wherein said first and second processors comprise a fault tolerant system.

17. The computer system of claim 9, wherein said first and second processors comprise a multi-processor system.

18. An upgradable computer system comprising:
a first software component and a second software component, said first and second software components operating at a current version;
means for upgrading the first software component to an upgraded version; and
means for validating the performance of the upgraded first software component, comprising means for translating messages originating at the first software component from an upgraded version format to a current version format.

19. The computer system of claim 18, further comprising a first processor executing the first software component and a second processor executing the second software component.

20. The computer system of claim 18, wherein the first software component comprises at least one interface, and said means for upgrading comprises upgrading the interface.

21. The computer system of claim 18, further comprising:
means for querying a version of the first software component and the second software component; and
means for determining a compatible version for the computer system.

22. A software component adapted to be used in a fault tolerant computer system, said component comprising:
an interface; and
a translation function;
wherein said translation function translates messages from said interface to a version common to all other software components of the computer system.

23. The software component of claim 22, wherein said interface is upgraded.
